(19) United States
(12) Patent Application Publication
(10) Pub. No.: US 2015/0104546 A1
(43) Pub. Date: Apr. 16, 2015

(54) WATER-SOLUBLE COFFEE PREPARATIONS

(71) Applicant: DMK Deutsches Milchkontor GmbH, Zeven (DE)

(72) Inventors: Thomas Mintus, Zeven (DE); Michael Hahn, Zeven (DE)

(21) Appl. No.: 14/510,292

(22) Filed: Oct. 9, 2014

(30) Foreign Application Priority Data
Oct. 15, 2013 (EP) 13 188 721.8

(51) Int. Cl. A23F 5/40; B65D 85/804

(52) U.S. Cl. CPC A23F 5/405; B65D 85/8046
USPC 426/93; 426/302; 426/115

(57) ABSTRACT

Soluble coffee preparations proposed are in the form of powders wherein the individual coffee particles have a complete or at least partial coating which dissolves in water in retarded fashion and which comprises not less than 50 wt % of the coffee powder.

### FIELD OF THE INVENTION

The invention resides in the field of coffee preparations and relates to a coated coffee powder and also to its method of making.

### PRIOR ART

Nespresso technology has revolutionized the coffee market in recent years. Although for coffee lovers nothing beats coffee made fresh from beans, there are also a large number of consumers who know how to appreciate a system where it is merely necessary to place a coffee pad in a machine in order to have, just a few seconds later, a coffee drink which leaves little to be desired in terms of taste. It is not only the time saving; enumerable types of coffee have become available in the meantime, making it easy to opt for a strong espresso in the morning, for a cappuccino at lunchtime and perhaps a café au lait in the evening—as the mood takes one.

It is particularly fancy coffees such as, for example, cappuccino or latte macchiato which are becoming increasingly popular. They consist essentially of two components, viz. a soluble coffee powder and a milk foam component, which is typically also in powder form. These preparations, however, are not entirely satisfactory. This is because, as a cappuccino powder dissolves in hot water, the foam has a conspicuous brown discoloration due to the coffee fraction. Even though this is immaterial to the taste, the visual appearance of such a product does differ quite decisively from that of a classic cappuccino, where the foam is only added afterwards.

It would be obvious at this point to separate the constituents of the preparation and simply to make the coffee first and only then the milk foam. But precisely this is not in accordance with consumer expectations of either merely dissolving a product in hot water or of merely placing a pad in a corresponding machine.

Reference may be made in this connection to the European patent document EP 2233013 B1 (Kraft) which discloses the coating of coffee powders with small amounts of tea extracts, polysaccharides, proteins and sugars. What the cited document precisely does not disclose, however, is coffee powders coated with very large amounts of soluble carbohydrates. Japanese patent application JP 4 071446 A2 (Isamu) proposes coating coffee powders with various extracts for the purpose of taste improvement. Dutch patent application NL 8800618 A1 (Douwen Egberts) teaches in the same direction by having coffee powder coated with caramelized sugar. Korean patent document KR 880002028 B1 (Bong) similarly recommends the coating of coffee powder with Ginseng aromas.

It is an object of the present invention to provide a very simple and reliable solution to the problem described at the beginning.

### DESCRIPTION OF THE INVENTION

The invention provides water-soluble coffee preparations in the form of powders wherein the individual coffee particles have a complete or at least partial coating which dissolves in water in retarded fashion and which comprises not less than 50 wt % of the coffee powder.

It was found that, surprisingly, coating the discrete particles of a coffee powder with a sufficient amount of a water-soluble carbohydrate retards the solubility of the coffee in hot water, i.e. when brewing up the fancy coffee, to such an extent that the milk foam can form without brownish discoloration due to proportionally co-dissolved coffee fractions.

### BRIEF DESCRIPTION OF THE DRAWING

The FIGURE schematically illustrates a dryer for use with the present invention.

### DESCRIPTION OF THE PREFERRED EMBODIMENTS

### Coffee Powder

The choice of coffee powder is not critical per se. Any ground coffee preparations may in principle be considered for use in that the origin is irrelevant unless it is important for the desired taste direction. Yet the particle size distribution of the powder in the end product is decisive for the taste of the manufactured end product. In one preferred embodiment of the invention, the coffee powders obtained after coating have a particle size distribution such that the D50 value is in the range from about 0.2 to about 1 mm. Coffee pads in particular should have a D50 value at the lower end, i.e. at about 0.2 to 0.4 mm. Particle size analysis may be performed using dynamic image processing for example.

### Coating

The coating applied to the coffee particles preferably consists of a soluble carbohydrate. Compounds considered for this purpose are selected from the group formed by monosaccharides, disaccharides, unmodified starches, chemically modified starches, hydrolyzed starches, maltodextrins, gum arabic and mixtures thereof.

Mono- and disaccharides which come into consideration for the purposes of the present invention include, for example, trioses, tetroses, pentoses, hexoses and heptoses, while pentoses and hexoses are preferable on account of their availability alone. The compounds which come into consideration for use are shown below in formula scheme 1. Of these compounds, it is glucose and mannose which are the preferred species by far.

Of the disacccharides, it is particularly cellubiose, gentiobiose, isomaltose, isomaltulose, lactose, lactulose, laminaribiose, maltose, maltulose, melibiose, neohesperidose, neotrehalose, nigerose, rutinose, sophorose, sucrose and trehalose which are suitable. Of these compounds, it is sucrose and maltose which are the most important.

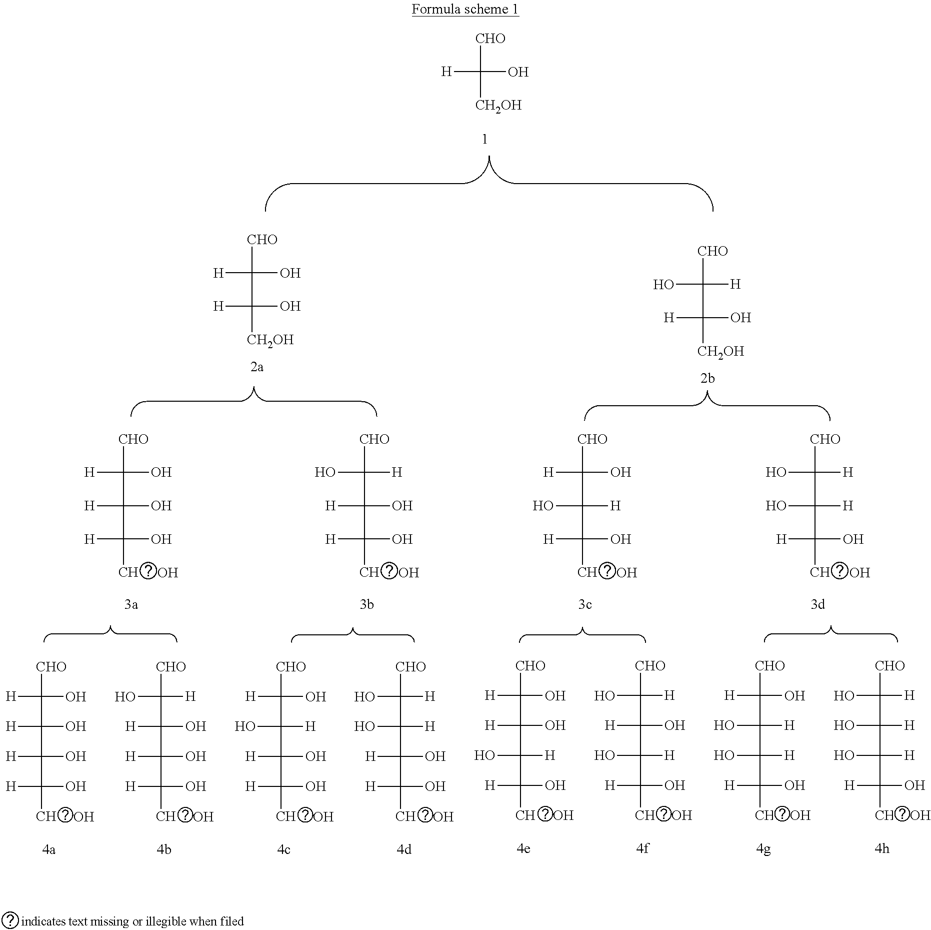

### Monosaccharides

In addition the mono- and disaccharides, useful coating components further include starches and starch breakdown products, provided they are approved for consumption. Starches such as maize, rice or tapioca starch and also corresponding hydrolyzates obtained by alkaline or enzymatic complete or partial breakdown are suitable for this purpose. Carboxymethylstarches in particular are suitable among the chemically modified starches.

Maltodextrins come between oligosaccharides and starch in terms of molecule size. They are typically in the form of white or pale yellow powder. They are primarily obtained from wheat, potato and maize starch by dry heating (>150° C.) or by the action of an acid. Dextrin is produced in nature by Bacterium macerans for examples. Dextrins are also formed by the enzymatic breakdown of starch by amylase.

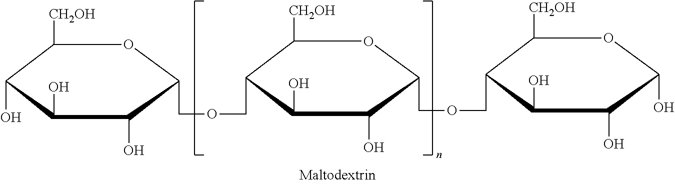

Maltodextrins of particular suitability have from about 3 to about 20, preferably from about 5 to about 15, dextrose equivalents (DE). This is to be understood as meaning the percentage share of reducing sugars in the dry matter.

The use of gum arabic is likewise preferable, since the powders thus coated dry particularly easily. Gum arabic is primarily a mixture of the acidic alkaline earth metal and alkali metal salts of poly arabic acid and/or branched polysaccharides consisting of L-arabinose, D-galactose, L-rhamnose and D-glucuronic acid in a ratio of 3:3:1:1.

In a further preferred embodiment, the coating may comprise lecithin, preferably soy lecithin. This leads to particularly stable adherence.

Coffee powders coated with a mixture of mono- or disacccharides, starch and/or gum arabic and lecithin are particularly preferable. A particularly advantageous coating preparation comprises from about 1 to about 20 g, preferably from about 5 to about 15 g and especially from about 5 to about 10 g of lecithin per kg of mono- or disaccharide solution.

Preparations of this type likewise preferably comprise from about 100 to about 300 g, preferably from about 150 to about 250 g and especially about 100 g of rice starch and/or tapioca starch per kg of mono- and/or disaccharide solution. The weight ratio of rice starch to tapioca starch therein is generally in the range from 1:5 to 1:20 and especially in the range from 1:7 to 1:15. A mono- and/or disaccharide solution here is a 50 to 85 wt % solution of glucose and/or sucrose in water. It is in this sense that a sugar syrup having, for example, about 75 Brix is particularly preferable.

In one altogether preferable embodiment of the invention, therefore, the coating consists of glucose and/or sucrose optionally in combination with starches, or of maltodextrins and/or gum arabic.

The amount of coating material used based on coffee powder is generally chosen such that, based on the proportional parts of solids, the resulting weight ratio is not less than 50, but preferably from about 80 to about 250 wt %, in particular from about 100 to about 150 wt % and more preferably from about 110 to 125 wt %. The two constituents are thus preferably present in approximately equal amounts. This ensures that, after coating, not less than 50 wt %, preferably not less than 60 wt % and especially from about 80 to about 90 wt % of the particles have a coating of soluble carbohydrate.

### Drying and Coating in Air-Flow Dryer

The present invention further provides a process for producing a water-soluble coffee preparation, wherein a first aqueous preparation comprising the coffee powder is dried, optionally granulated, and simultaneously coated with a second aqueous preparation comprising the soluble carbohydrate in an air-flow dryer. For this purpose, the aqueous starting materials are introduced into the dryer, preferably as solutions/dispersions, together or separately, for example by spraying them through nozzles. Appropriate nozzles, including multi-material nozzles, are well known from the prior art, for example from DE 10054359 A1 (Hüttlin).

It is possible in this connection for the residence time in the dryer of the starting material to be dried to be controlled not only via the air stream used for drying and/or built-in internals in the dryer, but also via the throughput rate of the conveyor and thus via the rate of the product's exit speed from the dryer. Control is preferably effected via the speed of the conveyor, since this represents a particularly simple and economical method of operation.

In order that incompletely dried starting material may not be carried out from the dryer in the course of the start-up phase thereof, the invention has a practical embodiment wherein an adjustable weir is arranged in the region of the dryer exit in the direction of the dispensing path such that the weir is completely closed during a start-up phase of the dryer only to be opened incrementally after a predetermined layer height has built up in the dryer and completely on conclusion of the start-up phase.

With regard to the productivity or the production capacity of a fluidized-bed drying apparatus, it is very important that the apparatus as a whole be uniformly traversable under full occupancy. This degree of occupancy or fill level of the dispensing device acting as connecting member between the dryer and the conveying means plays a determinative part. One incarnation of the process accordingly provides that as the weir opens, the linear speed of the conveying means is controlled so as to ensure complete filling of the dispensing device.

The granulation process must be considered as an integrated process from the point where the product to be granulated is loaded into the dryer through to the point where the granules are size classified by sieving. Sieving has a determinative influence on product quality. On the other hand, the mode of operating the sieve determines the output of the entire processing stage. It is accordingly of decisive importance that the sieve be operated at full capacity and uniformly. Since the sieve is charged by the conveyor while, on the other hand, the residence time of the starting material in the dryer is controlled via the linear speed of the conveying means, sieve occupancy can also be used to determine the loading rate of starting material to be granulated. A particularly advantageous incarnation of the to process accordingly provides that the linear speed of the conveyor be controlled by additionally taking into account uniform utilization of the full capacity of the downstream sieve and, if necessary, by controlling the rate of addition of the starting material to be granulated in a closed loop governed by seeking to maintain a predetermined height for the granules in the dryer.

In the device for drying granules according to the process of the present invention, the dispensing device is constructed in the form of a chute. This chute has a U-shaped cross section in preferred embodiments of the present invention. To avoid caking in the chute, plastic liners or air-flow metal sheets may be provided for the chute. Cloths which—like for example the plastic liners as well—can be agitated mechanically or using compressed air may also be employed. Constructing the dispensing device as a simple chute makes it possible that the dispensing device, which slopes towards the conveyor, be completely filled with granules from the dryer, so, on operation of the conveyor, the granules present on the dispensing device are carried away by the conveyor while at the same time fresh granules pass onto the sloping dispensing device from the dryer. This accordingly makes it possible to control the removal of the granules from the dryer and thus the residence time in the dryer of the starting material to be dried solely via the linear speed of the conveyor belt. An adjustable weir is preferably provided in the region of the dryer discharge towards the dispensing device.

A further embodiment of the invention is a proposal that the dryer be constructed as a rotating drum and that the linear speed of the conveying means be adjustable in relation to the speed of rotation of the dryer drum. This way of adjusting the linear speed of the conveying means and thus the rate of removal of the dried granules from the drum in relation to the speed of rotation of the drum makes it possible for a known moisture content for the starting material and a known drying air flow rate to adjust the device such that the granules have a very uniform moisture content at all times. The invention finally proposes that the dryer be constructed as a fluidized-bed dryer. Construction as a fluidized-bed dryer ensures rapid, uniform and economical drying of the moist starting material.

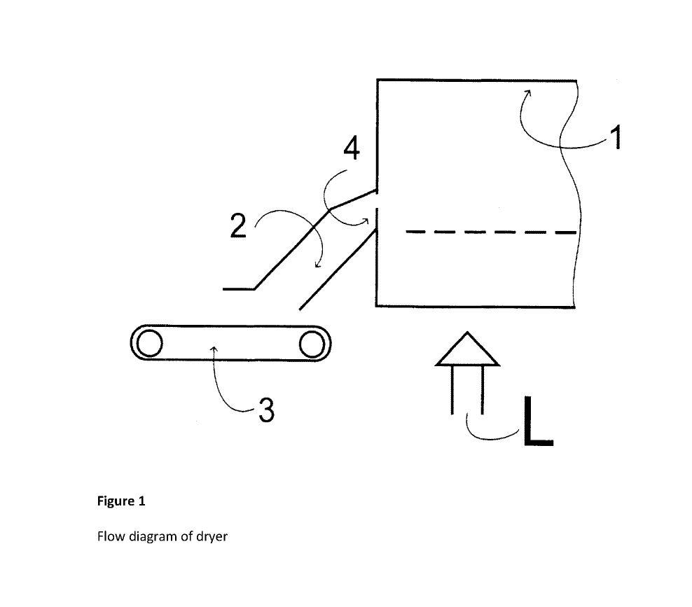

Such a device, consisting of a dryer (1), a dispensing device arranged at the exit side of the dryer and constructed as a chute (2), and also a conveyor (3) for carrying away the granules discharged from the dryer via the chute is reproduced in FIG. 1 by way of example.

To dry the starting material, the dryer—constructed as a rotating drum, for example—is fed with the moist starting material for drying within the dryer by means of an air stream L. The granules carried away by the conveyor are fed to subsequent sieves (not depicted) of various size of mesh in order to obtain a product in a uniform particle size band.

At the start of the operation, the conveyor is stationary until the chute has been completely filled with the granular product to be discharged. The conveyor is then switched on in order to carry away the granules. The operation of the conveyor carries away the granular product thus built up on the chute 2, while newly formed granules are subsequently continuously delivered to the chute from the dryer. The throughput rate of the conveyor can thus be used in a simple way to control the rate of emptying of the dryer and thus the residence time in the dryer 1 of the starting material to be dried.

The complete opening of the weir (4) on completion of the start-up phase puts an end to any overgranulation of coarse fractions in the dryer. In addition, control of the throughput rate of the conveyor makes it possible to maintain a constant fill level in the dryer and to improve the uniformity of the charging of the sieves downstream of the conveying means.

The device described above is thus altogether notable for the fact that the drying process can be run even in the case of a sensitive product such as coffee such that there is no overgranulation of coarse fractions which necessitate early cleaning of the dryer. The specific way of controlling the residence time of the starting material in the dryer via the throughput rate of the conveyor further makes it possible to charge the sieves downstream of the conveying means with the granular product more uniformly and thus to achieve near optimum utilization of their capacity.

In addition to the depicted embodiment of the dryer as a rotating drum, the dryer may also be constructed in some other form, for example as a fluidized-bed dryer. A fluidized bed is a bed of solid particles which is transformed into a fluidized state by an upwardly directed flow of a fluid. Fluidized beds therefore have liquid-like properties. They accordingly always have a horizontal surface, just like water. Objects having a higher density than the fluidized bed will sink in the bed, while objects of lower density float (Archimedes' Principle). Since the density—or to be more precise: the solid volume fraction in the mixture—of the fluidized bed changes with the rate of fluidization, objects having a density similar to that of the fluidized bed can be caused to sink or come back up to the surface by changing the fluidization rate. Fluidized beds feature close contact of the fluidized material (solid particles) with the fluidizing medium (a gas or liquid) and a vigorous interchange of positions between the individual particles in all direction. This is exploited to dry sensitive materials in a gentle manner while at the same time coating them with carrier substances.

The embodiment of the dryer as a fluidized-bed dryer is preferable in the context of the present invention. The fluidized-bed dryer of the present invention may be subdivided into various zones where not only the amount of air flowing through the individual zones but also the temperature in the individual zones are freely chooseable. When the dryer is subdivided into zones, it is particularly preferable for drying to take place in the first zones and cooling in the last zones.

The preference of the present invention is for fluidized-bed dryers where the material to be dried is transported in the direction of the dispensing device (2) by directed air flow, by a slope or by vibration. The floor plate of a fluidized-bed dryer refined in this way may have a slope, in which case the angle is advantageously between not less than 0 and less than 10°. However, it is also possible for the floor plate to be provided with openings to allow an air stream to pass through in the direction of the dispensing device. It is likewise possible for the floor to be configured as a perforated or valved floor in an agitated dryer (vibratory fluidized bed).

### Coating by Sugarcoating

In a further alternative embodiment of the invention, the coffee powders may be coated with the soluble carbohydrates by sugarcoating. Sugarcoating is generally a method of endowing a piece of confectionary or a tablet with a coating which, in the case of the medication, serves to improve the taste and consists of sugar. For the purposes of the present invention, however, this method is employed to coat the coffee powders layer by layer with a coating of soluble carbohydrates.

Sugarcoating preferably takes place in a pan in which the material to be sugarcoated—the coffee powder, that is—is introduced dry, but preferably at least incipiently moistened, as initial charge and then portionwise admixed with the carrier solution and dried. Repeating the operation two or more times creates a particularly thick layer, which is desired when the release of the coffee powder is to be retarded by more than 10 seconds.

### INDUSTRIAL APPLICABILITY

Two further subjects embraced by the present invention concern, first, a pulverulent mixture for dissolution in hot water and, secondly, a coffee capsule or coffee pad for placing in a coffee machine operating according to the Nespresso system, comprising the soluble coffee preparations and also a milk foam powder.

At the heart of Nespresso technology for coffee preparation is a capsule or pad, preferably an aluminium capsule, within which the entire brewing operation takes place. As the capsule is placed in the machine, it becomes enclosed by the capsule cage, is pressed downward against a so-called pyramidal plate and punctured by three pins from above. The brewing operation starts with hot water prepared in the machine being forced into the capsule under high pressure. As soon as the pressure within the capsule has become sufficiently high, the aluminium membrane on the bottom side of the capsule gives way and tears. The coffee brewed within the capsule is then able to flow out through the membrane thus apertured and through the holes of the pyramidal plate.

### EXAMPLES

### Production Example H1

### Production by Fluidized-Bed Drying

200 g of a commercially available coffee powder were initially charged in a little water, heated to a temperature of 50° C. and stirred until a homogeneous mixture forms. Thereafter, a carrier component consisting of 200 g of sucrose dissolved in 500 ml of water was provided and likewise heated to 50° C. The slurry of the coffee powder was then dispersed in the sucrose solution and the entire mixture was introduced into a fluidized-bed dryer at a temperature setting of 80 to 90° C.

### Production Example H2

### Production by Fluidized-Bed Drying

200 g of a commercially available coffee powder were initially charged in a little water, heated to a temperature of 50° C. and stirred until a homogeneous mixture forms.

Thereafter, a carrier component consisting of 200 g of a sugar syrup of 75 Brix was provided and likewise heated to 50° C. The slurry of the coffee powder was then dispersed in the sucrose solution and the entire mixture was introduced into a fluidized-bed dryer at a temperature setting of 80 to 90° C.

### Production Example H3

### Production by Fluidized-Bed Drying

200 g of a commercially available coffee powder were initially charged in a little water, heated to a temperature of 50° C. and stirred until a homogeneous mixture forms. Thereafter, a carrier component consisting of 150 g of sucrose, 40 g of a mixture of rice starch and tapioca starch (1:3) and also 10 g of soy lecithin dissolved in 500 ml of water was provided and likewise heated to 50° C. The slurry of the coffee powder was then dispersed in the carrier solution and the entire mixture was introduced into a fluidized-bed dryer at a temperature setting of 80 to 90° C.

### Production Example H4

### Production by Fluidized-Bed Drying

200 g of a commercially available coffee powder were initially charged in a little water, heated to a temperature of 50° C. and stirred until a homogeneous mixture forms. Thereafter, a carrier component consisting of 150 g of maltodextrin, 40 g of gum arabic and also 10 g of soy lecithin dissolved in 500 ml of water was provided and likewise heated to 50° C. The slurry of the coffee powder was then dispersed in the carrier solution and the entire mixture was introduced into a fluidized-bed dryer at a temperature setting of 80 to 90° C.

### Production Example H5

### Production by Sugarcoating

In a rotating sugarcoating pan (Erweka AR 401, speed 250 rpm), 200 g of a commercially available coffee powder were initially charged in a little water and admixed with 20 g of glucose in 50 ml of water. As soon as commixing of the inputs was complete, they were air dried until the powders had turned dusty (about 15 min). At this point the next layer was applied. The amount of sucrose solution per layer was individually determined such that the inputs had to be completely wetted but could not be allowed to become too wet in order to avoid any agglomeration. The operation was therefore repeated about 10 times. Total time for applying the layers was about 30 min.

### Performance Examples 1 to 5

In a first series of tests, 10 g quantities of each of the coated coffee powders obtained according to Production Examples H1 to H5 were dissolved in 100 ml of water at 60° C. while the browning of the solution was tracked in time. In a second series of tests, the preparations were each additionally admixed with 7 g of milk foam powder to see whether the milk foam assumed a brownish discoloration.

The results are shown in Table 1. T1 is the time elapsed from introducing the powder to when the first coloration was perceivable, while T2 is the time elapsed to complete dissolution of the coffee powder. The same uncoated coffee powder served as the standard for comparison.

TABLE 1
Solubility tests

| Ex. | Coffee powder | T1 [s] | T1 [s] | Discoloration |
|---|---|---|---|---|
| C | uncoated | 5 | 10 | distinct |
| 1 | H1 | 10 | 18 | very minimal |
| 2 | H2 | 12 | 22 | none |
| 3 | H3 | 12 | 23 | none |
| 4 | H4 | 14 | 25 | none |
| 5 | H5 | 17 | 27 | none |

A taste test was subsequently carried out on all coffee samples. None exhibited any off-flavour.

1. Water-soluble coffee preparations in the form of powders, wherein the individual coffee particles have a complete or at least partial coating which dissolves in water in retarded fashion and which comprises not less than 50 wt % of the coffee powder.

2. Preparations according to claim 1, wherein the coffee powder has a particle size distribution with a D50 value in the range from 0.2 to 1 mm.

3. Preparations according to claim 1, wherein the coating consists of a soluble carbohydrate.

4. Preparations according to claim 3, wherein the soluble carbohydrate is selected from the group formed by monosaccharides, disaccharides, unmodified starches, chemically modified starches, hydrolyzed starches, maltodextrins, gum arabic and mixtures thereof.

5. Preparations according to claim 1, wherein the coating consists of glucose and/or sucrose.

6. Preparations according to claim 1, wherein the coating consists of glucose and/or sucrose and also starch.

7. Preparations according to claim 1, wherein the coating consists of maltodextrin and/or gum arabic.

8. Preparations according to claim 1, wherein the coating further comprises lecithin.

9. Preparations according to claim 1, wherein the coating comprises from 80 to 120 wt % of the coffee powder.

10. Preparations according to claim 1, wherein not less than 50 wt % of the particles have a coating of a soluble carbohydrate.

11. Process for producing a water-soluble coffee preparation, wherein a first aqueous preparation comprising the coffee powder is dried and simultaneously coated with a second aqueous preparation comprising the soluble carbohydrate in an air-flow dryer.

12. Process according to claim 11, wherein the dryer is a fluidized-bed dryer.

13. Process for producing a water-soluble coffee preparation, wherein the coffee powder is sugarcoated with an aqueous preparation comprising the soluble carbohydrate.

14. Pulverulent mixture for dissolution in hot water, comprising the soluble coffee preparation according to claim 1 and a milk foam powder.

15. Coffee capsule or coffee pad for placing in a coffee machine operating according to the Nespresso system, comprising the soluble coffee preparation according to claim 1 and a milk foam powder.
